(19) United States
(12) Patent Application Publication
(10) Pub. No.: US 2014/0032370 A1
(43) Pub. Date: Jan. 30, 2014

(54) Automatically Linking Product Serial Numbers

(71) Applicant: Gary Rose, Charlotte, NC (US)

(72) Inventor: Gary Rose, Charlotte, NC (US)

(73) Assignee: Bank of America Corporation, Charlotte, NC (US)

(21) Appl. No.: 13/561,532

(22) Filed: Jul. 30, 2012

(51) Int. Cl. G06Q 30/06

(52) U.S. Cl. 705/26.81

(57) ABSTRACT

A system includes a processor operable to receive transaction information associated with a product purchased by a customer and determine a customer account associated with the customer. The transaction information includes an account identification, a generic product code, and a unique product identifier. The unique product identifier is operable to identify a single unit of the product from among a plurality of identical products and the generic product code is operable to indicate a description of the product. The processor is further operable to determine whether the unique product identifier and the generic product code should be stored in customer account information associated with the determined customer account, and store the unique product identifier and the generic product code in the customer account information if it is determined that the unique product identifier and the generic product code should be stored in the customer account information.

### TECHNICAL FIELD

This disclosure relates generally to the field of transactions and more specifically to automatically linking product serial numbers.

### BACKGROUND

Many products purchased by a consumer contain unique identifying codes that may be used to identify the product from among other identical products. For example, large appliances such as refrigerators, washer and dryers, dishwashers, and microwave ovens each contain a serial number that may be assigned to the appliance and used to distinguish it from other identical appliances. Serial numbers of products are especially useful in situations where a consumer has been victimized by theft or a natural disaster. For example, providing the serial numbers of stolen products to a law enforcement agency may aid in the recovery of the stolen property. In addition, providing a list of serial numbers of items affected by a natural disaster to an insurance agency may aid the consumer with his/her insurance claim. However, manually recording and storing serial numbers for products a consumer purchases is tedious and time consuming and therefore may not be performed on a regular basis.

### SUMMARY OF THE DISCLOSURE

In accordance with the present invention, the disadvantages and problems associated with documenting product purchases have been substantially reduced or eliminated.

According to one embodiment, a system includes a processor operable to receive transaction information associated with a product purchased by a customer and determine a customer account associated with the customer. The transaction information includes an account identification, a generic product code, and a unique product identifier. The unique product identifier is operable to identify a single unit of the product from among a plurality of identical products and the generic product code is operable to indicate a description of the product. The processor is further operable to determine whether the unique product identifier and the generic product code should be stored in customer account information associated with the determined customer account, and store the unique product identifier and the generic product code in the customer account information if it is determined that the unique product identifier and the generic product code should be stored in the customer account information.

Certain embodiments of the disclosure may provide one or more technical advantages. For example, when a consumer purchases a product from a merchant using a debit or credit card of a financial institution, the merchant may automatically transmit a serial number of the product to the financial institution. In particular embodiments, the financial institution may store the serial number of the purchased product in the consumer's account. The consumer may be able to view this serial number along with serial numbers of other products previously purchased. This may provide a benefit to the consumer because the consumer will have a list of serial numbers of products he/she has purchased that is automatically created and maintained without his/her input. Such a list may be very beneficial in events such as theft, disaster, or needed warranty repairs.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that automatically links product serial numbers with a consumer account, according to certain embodiments;

FIG. 2 illustrates example transaction information that may be utilized by the system of FIG. 1, according to certain embodiments;

FIG. 3 illustrates a graphical user interface in which the product serial numbers of FIG. 1 may be displayed, according to certain embodiments; and

FIG. 4 illustrates a method for automatically linking product serial numbers, according to certain embodiments.

### DETAILED DESCRIPTION OF THE DRAWINGS

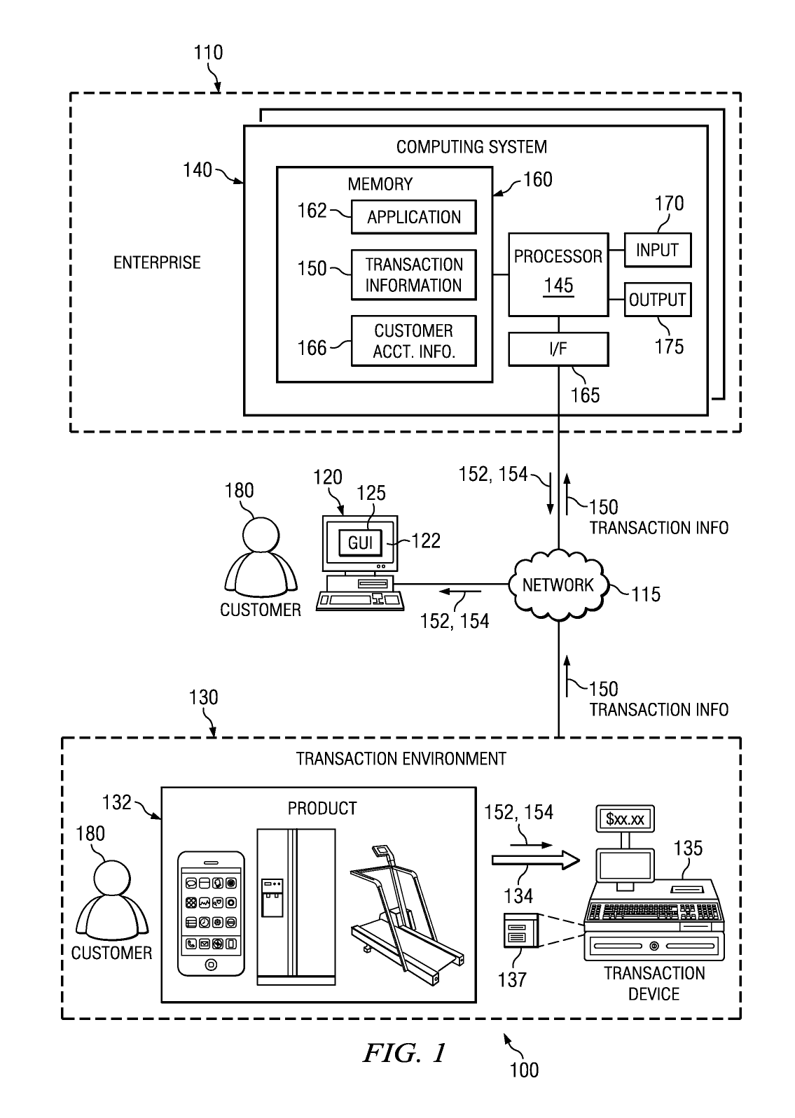

Embodiments of the present invention and its advantages are best understood by referring to FIGS. 1 through 4 of the drawings, like numerals being used for like and corresponding parts of the various drawings.

Customers of banks and other financial institutions typically purchase many types of products using credit and debit cards issued by the financial institution. For example, customers may purchase electronics, appliances, exercise equipment, and other products from merchants using credit and debit cards. Such products typically include a unique product identifier such as a serial number that distinguishes a single unit of the product from among many other identical products. For example, many identical brands and models of refrigerators may each have a unique serial number that may be used to identify each specific refrigerator.

In some situations, it is advantageous for a customer to have a list of products he/she has purchased along with each product's unique product identifier. For example, a customer may need to provide a list of purchased items and their serial numbers to a law enforcement agency in the event the customer is a victim of theft. Such a list may aid the law enforcement agency in the recovery of the stolen property. As another example, a customer may need to provide a list of purchased items and their serial numbers to an insurance agency in the event the customer is a victim of a natural disaster. However, keeping track of every item purchased and their respective serial numbers is cumbersome, tedious, and time consuming. As a result, many customers do not make an effort to create and maintain a list of purchased items and their serial numbers.

The teachings of the disclosure recognize that it would be desirable to automatically link product serial numbers to a customer's account. By automatically capturing and storing product serial numbers without any input or instructions from a customer, the product serial numbers of items purchased by the customer may be retrieved and viewed at any time. FIGS. 1 through 4 below illustrate a system and method for automatically linking product serial numbers according to the teachings of the disclosure.

FIG. 1 illustrates a system 100 according to certain embodiments. System 100 may include an enterprise 110, one or more clients 120 associated with one or more customers 180, and a transaction environment 130. Enterprise 110, clients 120, and transaction environment 130 may be communicatively coupled by a network 115. Enterprise 110 is generally operable to automatically link unique product identifiers 152 with a customer account, as described below.

In general, one or more computing systems 140 automatically link unique product identifiers 152 with a customer account in order to provide the customer with a list of his/her purchased products and their respective unique product identifiers 152. Customer 180 may first purchase a product 132 from a merchant in transaction environment 130. A transaction device 135 may utilize reception method 134 in order to obtain unique product identifier 152 from the purchased product 132. In some embodiments, unique product identifier 152 may be, for example, a serial number that may be obtained by scanning a digitized code on the purchased product 132. Transaction device 135 may then generate and transmit transaction information 150 to be received by computing system 140 in enterprise 110. Transaction information 150 may include, for example, the unique product identifier 152 of the purchased product 132 as well as other information such as the date of the transaction, an amount of money associated with the purchased product 132, an identification of the merchant, an identification of the customer's account at enterprise 110, a generic product code of the purchased product, and the like.

Computing system 140 may receive transaction information 150 and determine whether to store any of the information contained in transaction information 150 in the customer's account. Customer 180 may access his/her account using client 115 and view stored information from transaction information 150. For example, customer 180 may view products 132 that he/she has purchased along with each product's serial number. As a result, customer 180 is provided with a list of purchased products along with each product's unique product identifier 152 that is automatically generated and maintained without any input from customer 180. Such information may be especially useful if customer 180 is the victim of theft or natural disaster.

Transaction environment 130 represents any suitable components that allow customers 180 to perform transactions with merchants such as the purchase of products 132. In some embodiments, transaction environment 130 includes one or more transaction devices 135. Transaction device 135 represents any suitable components that verify and process a transaction between a customer 180 and a merchant. Transaction device 135 may include a cash register, a vending machine, a point-of-sale terminal, a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100 in order to input, verify, and process a transaction between a customer and a merchant. Transaction device 135 may comprise a user interface, such as a display, a microphone, keypad, credit/debit card terminal, a scanner (such as a barcode scanner), or other appropriate terminal equipment usable by a user.

Product 132 may be any product of any form that is purchased by customer 180. For example, product 132 may be any electronic device such as a television, smartphone, stereo system, computer, and the like. As other examples, product 132 may be any appliance, such as refrigerator, or any piece of fitness equipment such as a treadmill. The disclosure is not limited to any specific category or type of product 132.

In some embodiments, product 132 includes a unique product identifier 152. Unique product identifier 152 may be any unique identifier that may be used to identify a single unit of product 132 from among multiple identical products 132. For example, a merchant may sell a particular model of refrigerator from a particular manufacturer. Each one of the identical refrigerators may each have a unique product identifier 152 that may be used to identify that specific refrigerator. In some embodiments, unique product identifier 152 may be a serial number and may include any combination and amount of letters and numbers. In some embodiments, unique product identifier 152 may be found on product 132 itself (e.g., on a label attached to product 132), on packaging in which product 132 is located (e.g., encoded in a digital barcode), in a manual included with product 132, or any other suitable location.

In certain embodiments, product 132 includes a generic product code 154. Generic product code 154 may be any code that may be used to identify a particular brand and/or model of product 132. In some embodiments, unique product identifier 152 may refer to a universal product code (UPC). For example, a box of a television may include a UPC barcode. This UPC barcode may be scanned by, for example, transaction device 135, and used to determine the UPC of the particular product 132 that customer 180 is purchasing. While each unit of a specific brand and model of a particular product has its own unique product identifier 152, all units of the specific brand and model of the particular product will have an identical generic product code 154.

In some embodiments, transaction device 135 includes a transaction application 137. Transaction application 137 represents any suitable software or logic that allows transaction device 135 to input, verify, and process a transaction between a customer 180 and a merchant. Transaction application 137 further represents any suitable software or logic that allows transaction information 150 to be generated and communicated to computing system 140 of enterprise 110.

Client 120 may refer to any device that enables customer 180 to interact with computing system 140 and view unique product identifiers 152. In some embodiments, client 120 may include a computer, workstation, telephone, smartphone, tablet computer, Internet browser, electronic notebook, Personal Digital Assistant (PDA), pager, or any other suitable device (wireless, wireline, or otherwise), component, or element capable of receiving, processing, storing, and/or communicating information with other components of system 100. Client 120 may also comprise any suitable user interface such as a display 122, microphone, keyboard, or any other appropriate terminal equipment usable by a customer 180. It will be understood that system 100 may comprise any number and combination of clients 120. Customer 180 utilizes client 120 to interact with computing system 140 to receive and view information from transaction information 150, as described below.

In some embodiments, client 120 may include a graphical user interface (GUI) 125. GUI 125 is generally operable to tailor and filter data entered by and presented to customer 180. GUI 125 may provide customer 180 with an efficient and user-friendly presentation of information from transaction information 150 such as unique product identifier 152. GUI 125 may comprise a plurality of displays having interactive fields, pull-down lists, and buttons operated by user. GUI 125 may include multiple levels of abstraction including groupings and boundaries. It should be understood that the term GUI 125 may be used in the singular or in the plural to describe one or more GUIs 125 and each of the displays of a particular GUI 125.

In certain embodiments, network 115 may refer to any interconnecting system capable of transmitting audio, video, signals, data, messages, or any combination of the preceding. Network 115 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more computing systems 140. In some embodiments, computing system 140 may refer to any suitable combination of hardware and/or software implemented in one or more modules to process data and provide the described functions and operations. In some embodiments, the functions and operations described herein may be performed by a pool of computing systems 140. In some embodiments, computing system 140 may include, for example, a mainframe, server, host computer, workstation, web server, file server, a personal computer such as a laptop, or any other suitable device operable to process data. In some embodiments, computing system 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, computing system 140 provides information from transaction information 150 to customers 180. In some embodiments, computing systems 140 may include a processor 145, memory 160, an interface 165, an input 170, and an output 175. Memory 160 may refer to any suitable device(s) capable of storing and facilitating retrieval of data and/or instructions. Examples of memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates memory 160 as internal to computing system 140, it should be understood that memory 160 may be internal or external to computing system 140, depending on particular implementations. Also, memory 160 may be separate from or integral to other memory devices to achieve any suitable arrangement of memory devices for use in system 100.

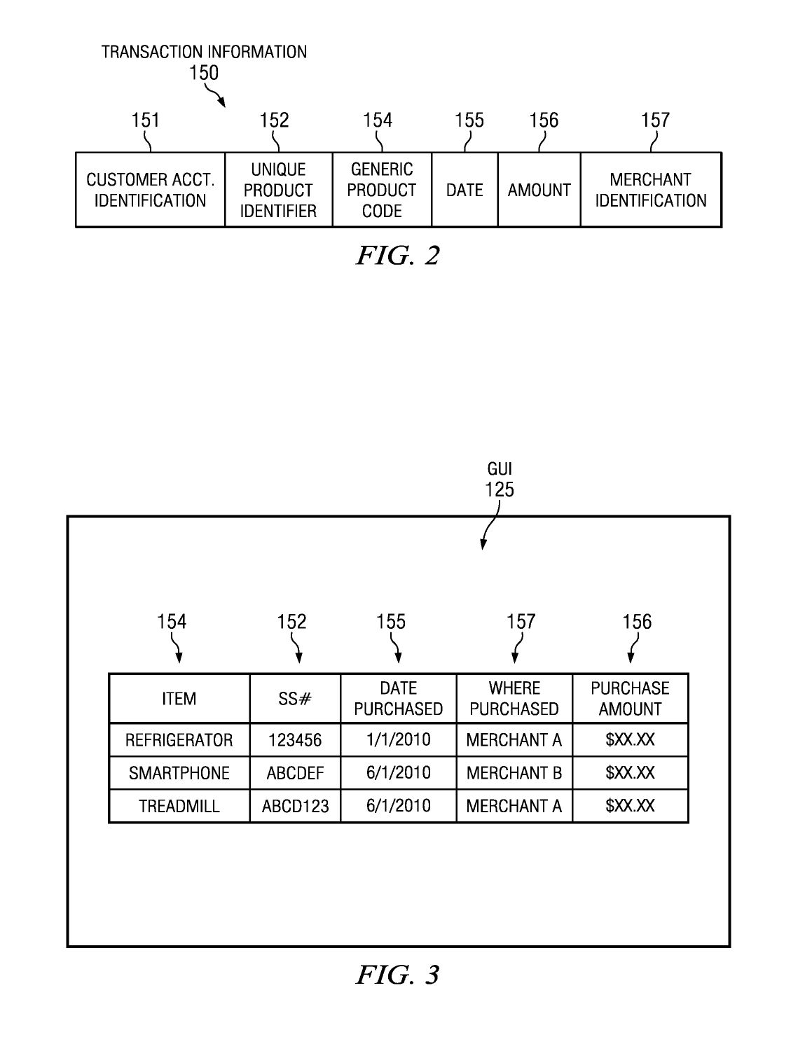

Memory 160 is generally operable to store an application 162, transaction information 150, and customer account information 166. Application 162 generally refers to logic, rules, algorithms, code, tables, and/or other suitable instructions for performing the described functions and operations. Transaction information 150 may be any information generated from a transaction involving customer 180 and a merchant in transaction environment 130. A particular embodiment of transaction information 150 is described in more detail below in reference to FIG. 2. Customer account information 166 may include any data regarding one or more customer accounts of enterprise 110.

Memory 160 is communicatively coupled to processor 145. Processor 145 is generally operable to execute application 162 stored in memory 160 to provide automatic linking of unique product identifiers 152 according to the disclosure. Processor 145 may comprise any suitable combination of hardware and software implemented in one or more modules to execute instructions and manipulate data to perform the described functions for computing systems 140. In some embodiments, processor 145 may include, for example, any type of central processing unit (CPU).

In some embodiments, communication interface 165 (I/F) is communicatively coupled to processor 145 and may refer to any suitable device operable to receive input for computing system 140, send output from computing system 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 115 or other communication system that allows computing system 140 to communicate to other devices. Communication interface 165 may include any suitable software operable to receive data that originated from various devices such as transaction device 135 or any other suitable device associated with transaction environment 130. Communication interface 165 may also include any suitable software operable to transmit data to various devices such as clients 120. Communication interface 165 may include one or more ports, conversion software, or both. In general, communication interface 165 receives transaction information 150 that was originally transmitted from transaction environment 130 and transmits information included in transaction information 150 to clients 120.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In operation, customer 180 initiates a transaction with a merchant in transaction environment 130. For example, customer 180 takes product 132 to a checkout station within transaction environment 130. Transaction device 135 may then utilize reception method 134 in order to obtain unique product identifier 152 and/or generic product code 154 associated with product 132. Reception method 134 may represent any method for receiving unique product identifier 152 and/or generic product code 154 associated with product 132. For example, reception method 134 may represent transaction device 135 scanning a barcode on product 132. In such an example, the barcode may be an image in the form of a linear barcode, matrix barcode, a sequence of numbers and/or symbols, any other suitable image, or any combination of the preceding. In another embodiment, reception method 134 may represent transaction device 135 receiving unique product identifier 152 and/or generic product code 154 associated with product 132 based on radio frequencies, such as frequencies associated with NFC or RFID. In another embodiment, reception method 134 may represent transaction device 135 receiving unique product identifier 152 and/or generic product code 154 associated with product 132 based on a user of transaction device 135 typing unique product identifier 152 and/or generic product code 154 into transaction device 135.

Once transaction device 135 has received unique product identifier 152 and/or generic product code 154 via reception method 134, transaction device 135 may generate transaction information 150. A specific example of transaction information 150 is discussed below in reference to FIG. 2. After generating transaction information 150, transaction information 150 is transmitted from transaction environment 130 to be received by computing system 140 of enterprise 110. Computing system 140 of enterprise 110 receives transaction information 150 and stores it in memory 160.

Computing system 140 accesses either received transaction information 150 or stored transaction information 150 that was generated by transaction environment 130. In some embodiments, computing system 140 determines a customer account associated with customer 180 from data in transaction information 150. For example, computing system 140 may analyze transaction information 150 in order to determine a customer account identification 151. In some embodiments, customer account identification 151 may be obtained from a credit or debit card of customer 180 and may include an account number, a name of customer 180, or any other information that may be utilized to identify an account of customer 180. Once customer account identification 151 is obtained from transaction information 150, computing system 140 may analyze customer account information 166 stored in memory 160 in order to determine an account associated with customer 180.

In some embodiments, computing system 140 determines whether unique product identifier 152 and generic product code 154 should be stored in customer account information 166 associated with the determined customer account of customer 180. In one example, computing system 140 determines that unique product identifier 152 and generic product code 154 should be stored in customer account information 166 if unique product identifier 152 contains any combination of letters and/or numbers. In another example, computing system 140 determines whether unique product identifier 152 and generic product code 154 should be stored in customer account information 166 by determining whether product 132 is a type of product that typically includes a unique product identifier 152. To do so, some embodiments access a list of generic product codes. This list may indicate known products having a unique product identifier 152 such as a serial number. Computing system 140 may then determine whether generic product code 154 of the purchased product 132 is included in the accessed list. If generic product code 154 of the purchased product 132 is found in the list, computing system 140 may store unique product identifier 152 and/or generic product code 154 in customer account information 166. If generic product code 154 of the purchased product 132 is not found in the list, computing system 140 may discard unique product identifier 152 and generic product code 154 and not store them in customer account information 166.

In certain embodiments, computing system 140 determines whether unique product identifier 152 and generic product code 154 should be stored in customer account information 166 by determining whether an amount of money spent purchasing product 132 is greater than or equal to a predetermined limit. For example, computing system 140 may access an amount 156 associated with the purchase of product 132 that is included in transaction information 150. Computing system 140 may then compare amount 156 to a predetermined amount. If amount 156 is greater than or equal to the predetermined amount, computing system 140 may store unique product identifier 152 and generic product code 154 in customer account information 166. If amount 156 is less than the predetermined amount, computing system 140 may discard unique product identifier 152 and generic product code 154 and not store them in customer account information 166.

As previously described, computing system 140 may receive transaction information 150 that was generated by transaction environment 130. For example, transaction environment 130 may automatically generate and transmit transaction information 150 to enterprise 110 after customer 180 purchases product 132 from a merchant. FIG. 2 illustrates certain embodiments of transaction information 150 that may be transmitted to and utilized by enterprise 110 as described herein.

In certain embodiments, transaction information 150 includes customer account identification 151, unique product identifier 152, generic product code 154, date 155, amount 156, and merchant identification 157. Customer account identification 151 may be obtained from a credit or debit card of customer 180 and may include an account number, a name of customer 180, or any other information that may be utilized to identify an account of customer 180. Date 155 may be the date of the transaction in which customer 180 purchased product 132. Amount 156 may be an amount of money customer 180 spent purchasing product 132. Merchant identification may be any appropriate code or string of characters that identifies the particular merchant from which customer 180 purchased product 132.

In operation, any device within transaction environment 130 may generate and transmit transaction information 150. For example, transaction device 135 may generate transaction information 150 after or during a transaction in which customer 180 purchases product 132. As described above, transaction device 135 may utilize reception method 134 to obtain unique product identifier 152 and generic product code 154. In addition, transaction device 135 may obtain customer account identification 151 from a credit or debit card of customer 180. After obtaining unique product identifier 152, generic product code 154, and customer account identification 151, transaction device 135 may generate transaction information 150 and transmit it to computing system 140 in enterprise 110.

Computing system 140 of enterprise 110 may store transaction information 150 in customer account information 166 and present information from transaction information 150 to customer 180 at the customer's request. For example, customer 180 may access his/her purchased products and their associated unique product identifier 152 using GUI 125 and display 122 of client 120. An example embodiment of GUI 125 is illustrated in FIG. 3 below.

FIG. 3 illustrates one embodiment of GUI 125 in which products 132 and their associated unique product identifier 152 are presented to customer 180. In this particular embodiment, a list of products 132 is presented to customer 180 in tabular format. Each line of the table is associated with a particular product 132 that was previously purchased by customer 180. Each line of the table in this embodiment includes generic product code 154, unique product identifier 152, date 155, merchant identification 157, and amount 156 associated with a particular product 132. For example, the first line indicates that a product having a generic product code 154 of “REFRIGERATOR” and a unique product identifier 152 of “123456” was purchased on Jan. 1, 2010 from MERCHANT A for $XX.XX. As another example, the second line indicates that a product having a generic product code 154 of “SMARTPHONE” and a unique product identifier 152 of “ABCDEF” was purchased on Jun. 1, 2010 from MERCHANT B for $XX.XX. Information such as the information illustrated in FIG. 3 may be very useful to customer 180. For example, if customer 180 is the victim of theft, customer 180 may utilize a client 120 to access his/her account with enterprise 110 and be presented with a list of his/her purchased products and their associated serial numbers. This list may then be provided to a law enforcement agency and used to help recover the stolen property. In addition, information from transaction information 150 may be automatically generated and transmitted to enterprise 110 without any input or direction from customer 180. This provides an additional benefit because customer 180 is not required to take any action to store or maintain information regarding purchased products.

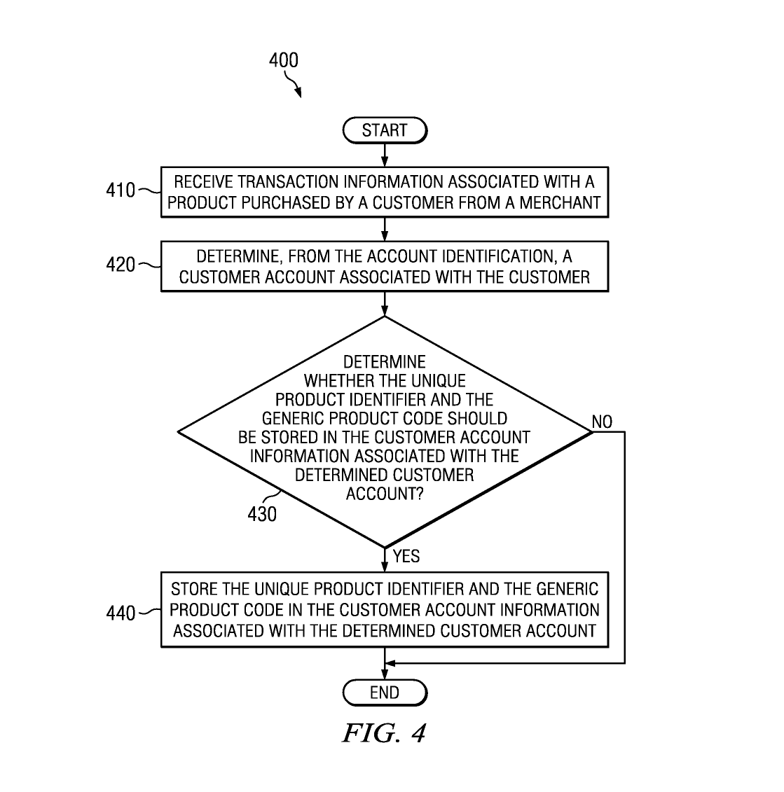

FIG. 4 illustrates a method 400 for automatically linking product serial numbers. Method 400 may be implemented, for example, by application 162 in computing system 140. Method 400 begins in step 410 where transaction information associated with a product purchased by a customer from a merchant is received. In some embodiments, the received transaction information refers to transaction information 150 described above. In some embodiments, the received transaction information is generated by and received from transaction device 135. In certain embodiments, the transaction information includes an account identification such as customer account identification 151, a generic product code such as generic product code 154, a unique product identifier such as unique product identifier 152, a date such as date 155, an amount of money such as amount 156, and a merchant identification such as merchant identification 157 described above. In certain embodiments, the generic product code is operable to indicate a description of the product purchased by the customer and the unique product identifier is operable to identify a single unit of the product from among a plurality of identical products.

In step 420, a customer account associated with the customer is determined from the account identification of step 410. In certain embodiments, this may include searching customer account information such as customer account information 166 for the account identification of step 420.

In step 430, it is determined whether the unique product identifier and the generic product code of the received transaction information of step 410 should be stored in the customer account information associated with the determined customer account of step 420. In certain embodiments, step 430 includes accessing a list of generic product codes and determining whether the generic product code of the product purchased by the customer is included in the list. If the generic product code of the product is included in the list, method 400 proceeds to step 440 where the unique product identifier and the generic product code of the received transaction information of step 410 are stored in the customer account information associated with the determined customer account of step 420. If the generic product code of the product is not included in the list, method 400 ends and the unique product identifier and the generic product code of the received transaction information of step 410 are not stored in the customer account information associated with the determined customer account of step 420.

In some embodiments, step 430 includes comparing the amount of money indicated in the received transaction information of step 410 to a predetermined limit. If the amount of money is greater than or equal to the predetermined limit, method 400 proceeds to step 440 where the unique product identifier and the generic product code of the received transaction information of step 410 are stored in the customer account information associated with the determined customer account of step 420. If the amount of money is less than the predetermined limit, method 400 ends and the unique product identifier and the generic product code of the received transaction information of step 410 are not stored in the customer account information associated with the determined customer account of step 420.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system comprising:
a memory operable to store customer account information associated with a plurality of customers; and
a processor communicatively coupled to the memory, the processor operable to:
receive transaction information associated with a product purchased by a customer from a merchant, the transaction information comprising at least an account identification, a generic product code, and a unique product identifier, wherein:
the unique product identifier is operable to identify a single unit of the product from among a plurality of identical products;
the generic product code is operable to indicate a description of the product;
determine, from the account identification, a customer account associated with the customer;
determine whether the unique product identifier and the generic product code should be stored in the customer account information associated with the determined customer account; and
store the unique product identifier and the generic product code in the customer account information associated with the determined customer account if it is determined that the unique product identifier and the generic product code should be stored in the customer account information.

2. The system of claim 1, wherein the unique product identifier comprises a serial number.

3. The system of claim 1, wherein the generic product code comprises a universal product code (UPC).

4. The system of claim 1, wherein determining whether the unique product identifier and the generic product code should be stored in the customer account information associated with the determined customer account comprises:
accessing a list comprising a plurality of generic product codes;
determining whether the generic product code of the product purchased by the customer is included in the list;
determining that the unique product identifier and the generic product code should be stored in the customer account information associated with the determined customer account if the generic product code of the product is included in the list; and
determining that the unique product identifier and the generic product code should not be stored in the customer account information associated with the determined customer account if the generic product code of the product is not included in the list.

5. The system of claim 1, the transaction information further comprising an amount of money associated with the product purchased by the customer, wherein determining whether the unique product identifier and the generic product code should be stored in the customer account information associated with the determined customer account comprises:
comparing the amount of money to a predetermined limit;
determining that the unique product identifier and the generic product code should be stored in the customer account information associated with the determined customer account if the amount of money is greater than or equal to the predetermined limit; and
determining that the unique product identifier and the generic product code should not be stored in the customer account information associated with the determined customer account if the amount of money is less than the predetermined limit.

6. The system of claim 1, further comprising:
a transaction application for execution on a transaction device associated with the merchant, the transaction application operable, upon execution, to:
determine the unique product identifier and the generic product code of the product purchased by the customer;
generate the transaction information; and
transmit the transaction information.

7. The system of claim 6, wherein determining the unique product identifier and the generic product code of the product purchased by the customer occurs automatically and in the absence of instructions from the customer.

8. One or more non-transitory computer-readable media comprising logic, the logic when executed by a processor operable to:
receive transaction information associated with a product purchased by a customer from a merchant, the transaction information comprising at least an account identification, a generic product code, and a unique product identifier, wherein:
the unique product identifier is operable to identify a single unit of the product from among a plurality of identical products;
the generic product code is operable to indicate a description of the product;
determine, from the account identification, a customer account associated with the customer;
determine whether the unique product identifier and the generic product code should be stored in customer account information associated with the determined customer account;
store the unique product identifier and the generic product code in the customer account information associated with the determined customer account if it is determined that the unique product identifier and the generic product code should be stored in the customer account information.

9. The logic of claim 8, wherein the unique product identifier comprises a serial number.

10. The logic of claim 8, wherein the generic product code comprises a universal product code (UPC).

11. The logic of claim 8, wherein determining whether the unique product identifier and the generic product code should be stored in the customer account information associated with the determined customer account comprises:
accessing a list comprising a plurality of generic product codes;
determining whether the generic product code of the product purchased by the customer is included in the list;
determining that the unique product identifier and the generic product code should be stored in the customer account information associated with the determined customer account if the generic product code of the product is included in the list; and
determining that the unique product identifier and the generic product code should not be stored in the customer account information associated with the determined customer account if the generic product code of the product is not included in the list.

12. The logic of claim 8, the transaction information further comprising an amount of money associated with the product purchased by the customer, wherein determining whether the unique product identifier and the generic product code should be stored in the customer account information associated with the determined customer account comprises:
comparing the amount of money to a predetermined limit;
determining that the unique product identifier and the generic product code should be stored in the customer account information associated with the determined customer account if the amount of money is greater than or equal to the predetermined limit; and
determining that the unique product identifier and the generic product code should not be stored in the customer account information associated with the determined customer account if the amount of money is less than the predetermined limit.

13. A method, comprising:
receiving transaction information associated with a product purchased by a customer from a merchant, the transaction information comprising at least an account identification, a generic product code, and a unique product identifier, wherein:
the unique product identifier is operable to identify a single unit of the product from among a plurality of identical products;
the generic product code is operable to indicate a description of the product;
determining from the account identification, a customer account associated with the customer;
determining whether the unique product identifier and the generic product code should be stored in customer account information associated with the determined customer account;
storing the unique product identifier and the generic product code in the customer account information associated with the determined customer account if it is determined that the unique product identifier and the generic product code should be stored in the customer account information.

14. The method of claim 13, wherein the unique product identifier comprises a serial number.

15. The method of claim 13, wherein the generic product code comprises a universal product code (UPC).

16. The method of claim 13, wherein determining whether the unique product identifier and the generic product code should be stored in the customer account information associated with the determined customer account comprises:
accessing a list comprising a plurality of generic product codes;
determining whether the generic product code of the product purchased by the customer is included in the list;
determining that the unique product identifier and the generic product code should be stored in the customer account information associated with the determined customer account if the generic product code of the product is included in the list; and
determining that the unique product identifier and the generic product code should not be stored in the customer account information associated with the determined customer account if the generic product code of the product is not included in the list.

17. The method of claim 13, the transaction information further comprising an amount of money associated with the product purchased by the customer, wherein determining whether the unique product identifier and the generic product code should be stored in the customer account information associated with the determined customer account comprises:
comparing the amount of money to a predetermined limit;
determining that the unique product identifier and the generic product code should be stored in the customer account information associated with the determined customer account if the amount of money is greater than or equal to the predetermined limit; and
determining that the unique product identifier and the generic product code should not be stored in the customer account information associated with the determined customer account if the amount of money is less than the predetermined limit.

18. The method of claim 13, further comprising:
determining the unique product identifier and the generic product code of the product purchased by the customer;
generating the transaction information; and
transmitting the transaction information.

19. The method of claim 18, wherein determining the unique product identifier and the generic product code of the product purchased by the customer occurs automatically and in the absence of instructions from the customer.

20. The method of claim 13, wherein the transaction information further comprises a merchant identification and a date associated with the purchase of the product by the customer.
